(19) United States
(12) Patent Application Publication
(10) Pub. No.: US 2006/0059344 A1
(43) Pub. Date: Mar. 16, 2006

(54) Service authentication

(75) Inventor: Risto Mononen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/984,902

(22) Filed: Nov. 10, 2004

(30) Foreign Application Priority Data
Sep. 10, 2004 (EP) EP 04 021 602.0

(51) Int. Cl. H04L 9/00

(52) U.S. Cl. 713/171

(57) ABSTRACT

A system and method of receiving key information for calculating at least one password by a user equipment from a communication network system via a secure channel, generating at least one password on the basis of the key information in the user equipment, and performing authentication between the user equipment and the communication network system using the at least one password.

### FIELD AND BACKGROUND OF THE INVENTION

In general, the present invention relates to service authentication, and in particular to a communication system comprising user equipments and a communication network system, in which a user equipment performs authentication with the communication network system by using passwords.

Passwords will provide the most widely accepted authentication method for the foreseeable future. Password based authentication will be readily available independently of network and device technologies. The password security and management should be improved to reach the largest possible user base without authentication being the bottleneck for launching new services in mobile networks. Recently mobile operator's WLAN (Wireless Local Area Network) and xDSL (Digital Subscriber Line) authentication and access independent use of IMS (IP Multimedia Subsystem) and PoC (Push to talk over Cellular) services have suffered from strong coupling between the authentication, access network and terminal technologies.

### SUMMARY OF THE INVENTION

It is an object of the invention to provide an effective password delivery in communication systems.

According to an aspect of the invention, this object is achieved by receiving key information for calculating at least one password by a user equipment from a communication network system via a secure channel, generating at least one password on the basis of the key information in the user equipment, and performing authentication between the user equipment and the communication network system using the at least one password.

According to an embodiment of the invention, to minimize the SMS (Short Message Service) load that a conventional http digest password delivery causes, a Seed and Hash Approach is used. An entity in the communication network system, e.g. an operator's own service management system with a terminal management server generates the seed and optionally a (new) secret key, and sends it/them to the user equipment or terminal over SMS. The service management system generates and sends a new seed (and secret key) to the terminal after the number of generated passwords reaches a configurable threshold or a timeout expires.

Requiring a subscriber to enter a PIN code before applying the hash function enhances the security of the mechanism. Applying different seeds, secret keys and/or hash functions can create password domains.

Minimal SMS load on a PoC password delivery is a relevant use case. Other operator's applications can use the same mechanism with possibly separate password spaces. Even a third party service provider can deliver the information for generating the one-time passwords over SMS or from a (TLS (Transport Layer Security) protected) web page.

The invention minimizes the SMS load in PoC password delivery. Other applications in addition to PoC can use the delivered passwords as well. The passwords are access and terminal technology independent authentication mechanism. Conventional authentication may have suffered from lack of SIM (Subscriber Identity Module) support, or slow deployment of SIM smartcards. The secure password delivery over SMS or some other trusted channel (HTTP (HyperText Transport Protocol)/TLS) according to the invention removes this obstacle altogether benefiting all the future applications.

Often the mobile operator's control over the smartcards and authentication is considered too strong. According to the invention, passwords are not dependent on any smartcard and therefore there is more freedom in selecting alternative trust providers for the terminals.

The terminal and the server must use the passwords in synchronism. For this purpose, the server may advise the terminal about a correct next password id. Alternatively, the server may allow a sliding window of passwords so that the N closest passwords are allowed in addition to the correct one. As the last resort the terminal can request a new seed to re-synchronize.

As the one-time passwords do not provide mutual authentication, e.g. server certificates may be used for this purpose.

### BRIEF DESCRIPTION OF THE DRAWINGS

FIG. 1 shows a schematic diagram illustrating a system for effective password delivery according to the invention.

FIG. 2 shows an OTP architecture according to an embodiment of the invention.

FIG. 3 shows a table illustrating OTP generation data and terminology.

FIG. 4 shows an OTP generation and delivery according to an embodiment of the invention.

FIG. 5 shows an OTP usage according to an embodiment of the invention.

FIG. 6 shows an OTP synchronization according an embodiment of the invention.

FIG. 7 shows an OTP synchronization according an embodiment of the invention.

FIG. 8 shows an OTP revocation according to an embodiment of the invention.

FIG. 9 shows an OTP revocation according to an embodiment of the invention.

FIG. 10 shows an OTP revocation according to an embodiment of the invention.

### DESCRIPTION OF THE PREFERRED EMBODIMENTS

The present invention is concerned with password usage for enabling multi-access and multi-terminal use cases. Passwords provide the most widely accepted authentication method when considering all Internet access and terminal technologies in use today. Recent development in WLAN authentication and PCs may bring smartcard-based authentication to a wider variety of terminals in the future, but nevertheless the password authentication does not show any signs of being displaced. From the network business perspective it is desirable that a trusted channel can be used without any mobile operator involvement, but the home operator can add value with some additional function or improved security.

Password based authentication will be readily available independently of the network and device technologies. In the following it will be described how password security and management can be improved to reach the largest possible user base without authentication being the bottleneck for launching new services. The design philosophy is “always use the cellular network as the trusted channel for password management” (rather than the conventional one “always use the xSIM as the trusted authentication token”). In general the password management consists of:
1. Initial password delivery
2. Password change
3. Password revocation

One-time passwords (OTP) can be used only once as the name indicates. Thus the change step above is not needed at all. Revocation may be needed depending on the value of the service. OTPs may be delivered as a list of random numbers, which the user must store securely. Another mechanism uses a secret pass-phrase to generate a sequence of one-time (single use) passwords.

In IP Multimedia core access authentication operator's own service management system with a terminal management server should be able to support OMA (Open Mobile Alliances) OTA (Over The Air) and PoC industry standard based access authentication method including secure password delivery logistics. However, this creates a lot of SMS traffic, which cannot necessarily be charged by the operator. SMS delivery is not instant and it is not guaranteed. This increases probability to end up in a situation where the terminal and network have different passwords, which decreases usability from end users' point of view.

Several operating systems including Windows NT force the user to change the password after a regular time interval. The user can select a weak password and typically the interval is quite long.

Known S/Key and OTP mechanisms generate a sequence of passwords by applying a hash function to a seed, secret key and the previous password.

Moreover, it has been proposed that SIM based IMS (IP Multimedia Subsystem) terminals will use shared secret based http digest authentication mechanism. The passwords as well as IMPI (IP Multimedia Private Identity) and IMPU (IM Public Identity) have to be delivered into a memory of the mobile terminal to be used later with SIP (Session Initiation Protocol) authentications. Because these stored passwords are targeted for IMS authentication, end-users should not be able to see them during the delivery or after the delivery. The proposed approach is that the service management system will have capabilities to generate these passwords automatically for end-users when requested. The service management system should then store the password and deliver it also to the mobile terminal in question. The delivering could happen via a terminal management server by using smart messages. However the delivery mechanism should be such that an end-user is not able to see the password in question. In case of USIM (User Service Identity Module) or ISIM (IM Services Identity Module) use in new terminals, IMS AKA authentication based on shared secret (K) is used.

Furthermore it has been proposed how the RAND challenges can be split to different domains to avoid their usage in an incorrect context. E.g. GSM (Global System for Mobile communications) and GPRS (General Packet Radio Services) may have separate RAND spaces. The present invention describes mechanisms to split the password domains.

The present invention focuses mainly on decreasing the amount of SMS traffic. Usability in the case of out of sync passwords and detecting malicious users are secondary concerns.

The password delivery according to the present invention to be described in the following involves at least a UE (User Equipment) and one or more network elements, which accept the password. Network elements may also generate the passwords since user selected ones are typically too weak for subscriber (charging) security. (It is to be noted here that the password management is different from the password usage.)

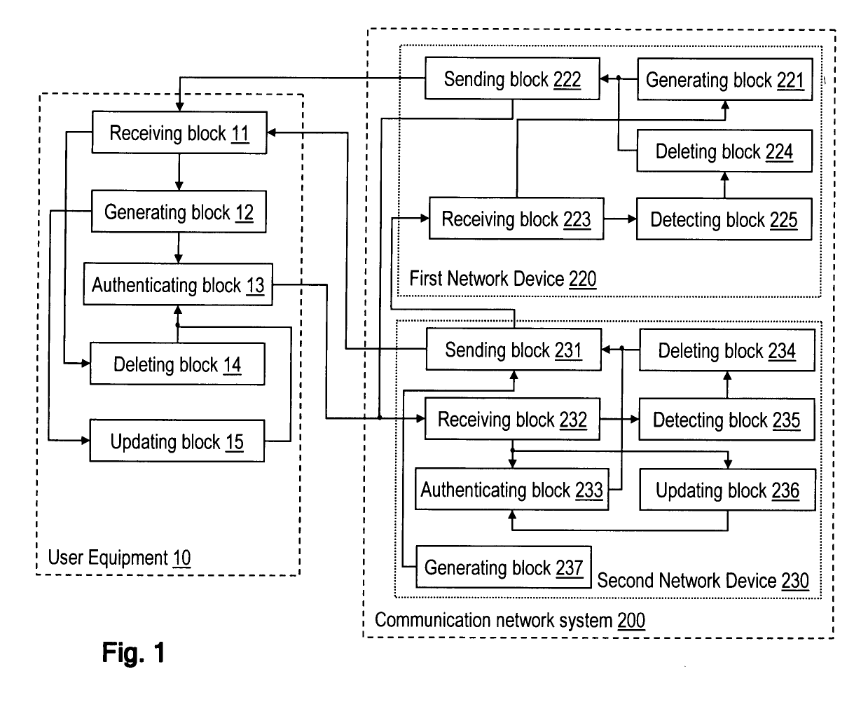

FIG. 1 shows a schematic diagram illustrating a user equipment 10 and a communication network system 200 according to the invention. The communication network system 200 may comprise a first network entity 220 and a second network entity 230. Alternatively, the functions of the first and second network entities may be performed in a single network entity of the communication network system 200. The user equipment 10 together with the communication network system 200 forms a communication system. According to an embodiment of the invention, the user equipment 10 may be a mobile terminal, the first network entity 220 may be a subscription management entity in a home domain of the mobile terminal, and the second network entity 230 may be a serving entity or authentication proxy in a service domain of the mobile terminal. The first and/or second network entity may also be located/running in a mobile node or in a UE. In case of ad-hoc networking with multiple devices of a single subscriber, some of them may be in a master role (like the subscription management entity) and they may provide services to each other (like the authentication proxy to the user equipment).

The user equipment 10 comprises a receiving block 11, a generating block 12 and an authenticating block 13. The user equipment 10 may further comprise a deleting block 14 and an updating block 15. The receiving block 11 receives key information for calculating at least one password from the communication network system via a secure channel. The key information may comprise a long-term secret key of the user equipment. The secure channel may be an SMS message or encrypted IPSec or TLS connection. The key information may be received from the first network entity 220 acting as subscription management entity.

The generating block 12 generates the at least one password on the basis of the received key information, and the authenticating block performs authentication with the communication network system, e.g. the second network entity 230 acting as authentication proxy using the generated password.

The first network entity 220 includes a generating block 221 and a sending block 222. It may further include a receiving block 223, a deleting block 224 and a detecting block 225. The generating block 221 generates key information for the user equipment 10, and the sending block 222 sends the key information to the user equipment 10 via the secure channel.

The second network entity 230 comprises a sending block 231, a receiving block 232 and an authenticating block 233. It may further comprise a deleting block 234, a detecting block 235, an updating block 236 and generating block 237. The sending block sends a request for generating a password to the user equipment 10 in case the user equipment 10 requests a service. The request includes encryption data for generating at least one password in the user equipment 10. The encryption data may have been generated by the generating block 237. The encryption data may comprise not confidential data and may comprise a server's key, which is different for each server, and a number N of secure hash runs needed to generate a next OTP (One-Time Password). When the receiving block 232 receives the password generated on the basis of the encryption data from the user equipment 10, the authenticating block 233 verifies the password.

The generating block 12 of the user equipment 10 may generate the password on the basis of a combination of the key information and the encryption data. In generating the password a secure hash function may be applied to the combination of the key information and the encryption data.

The receiving block 11 of the user equipment 10 may receive a request for generating a password from the communication network system 200, e.g. the second network entity 230 acting as authentication proxy, the request including encryption data, and the generating block 12 of the user equipment 10 may generate the password in response to the request using the key information and the encryption data included in the request.

The receiving block 11 of the user equipment 10 may receive a revocation request for revoking a password from the communication network system, i.e. the first network entity 220 or the second network entity 230. In response thereto the deleting block 14 may delete the key information and the encryption data used for the password generation. If the first network entity 220 sent the revocation request, the deleting block 14 may delete all the key information and encryption data. If the second network entity 230 sent the revocation request, the deleting block 14 may delete only the encryption data related to that particular network entity.

Also the user equipment 10 may contain a detection block (not shown), which automatically triggers key deletion. E.g. smartcards can erase the key material if they detect suspicious activity like changes in the input voltage, etc.

For synchronizing purposes, the updating block 15 of the user equipment 10 may decrease a count value (N) indicating validity of the encryption data with every password calculation. The decrement may be one or more.

The receiving block 223 of the first network entity 220 may receive a request for generating a password from the second network entity 230 acting as service management entity of the communication network system 200, the request including encryption data. In response thereto the generating block 221 of the first network entity 220 may generate a password using the generated key information and the received encryption data, and the sending block 222 of the first network entity 220 sends the password to the second network entity 230.

In case the detecting block 224 of the first network entity 220 detects a non-permitted use of the user equipment 10, the deleting block 224 of the first network entity 220 may delete the key information, and the sending block 222 of the first network entity 220 sends a revocation request to the user equipment 10. The sending block 222 of the first network entity 220 also sends a revocation request to the second network entity 230 so that it may delete the encryption data related with the this particular user equipment 10.

Although FIG. 1 shows merely one user equipment and one second network device, there may be several simultaneous instances of User Equipment and Second Network Device with different keys.

As mentioned above, the sending block 231 of the second network entity 230 may send the request for generating a password to the first network entity 220 acting as subscriber management entity of the communication network system 200. In this case, the receiving block 232 of the second network entity 230 may receive the password from the first network entity 220, and the authenticating block 233 may verify the password received from the user equipment 10 on the basis of the password received from the first network entity 220.

In case the authentication block 233 of the second network entity 230 does not verify the password from the user equipment 10, the sending block 231 may re-send a request for generating a password to the user equipment 10, the request including updated encryption data.

In case the detecting block 235 of the second network entity 230 detects a non-permitted use of the user equipment 10, the deleting block 234 may delete the password received from the user equipment 10 and the sending block 231 of the second network entity 230 sends a revocation request to the user equipment 10.

For synchronizing purposes the updating block 236 may decrease a count value.(N) indicating the validity of the encryption data with every password received from the user equipment 10. The second network entity 230 may indicate the correct count value (N) to the User Equipment 10.

It is to be noted that FIG. 1 shows the elements of the user equipment and the communication network system, which are necessary for understanding the present invention. Of course the user equipment as well as the communication network system may comprise further elements, which are necessary for their functioning as user equipment and communication network system, respectively. Moreover, the blocks of the user equipment or the blocks of the first and second network entities may be combined so that several functions are performed in a single block.

Alternatively, operations performed in one block may be further separated into sub-blocks.

The operations performed in the blocks shown in FIG. 1 may be implemented in hardware and/or software.

In the following an embodiment of the invention will be described which is based on OTP (One-Time Password) architecture.

As it will be seen from the following description, in the one-time password schemes the use of a one-way function (“hash”) is essential to the security. The hash function h( ) will be run several times on the encryption data to get the current key, e.g.:
h(h(h(h(data)))).

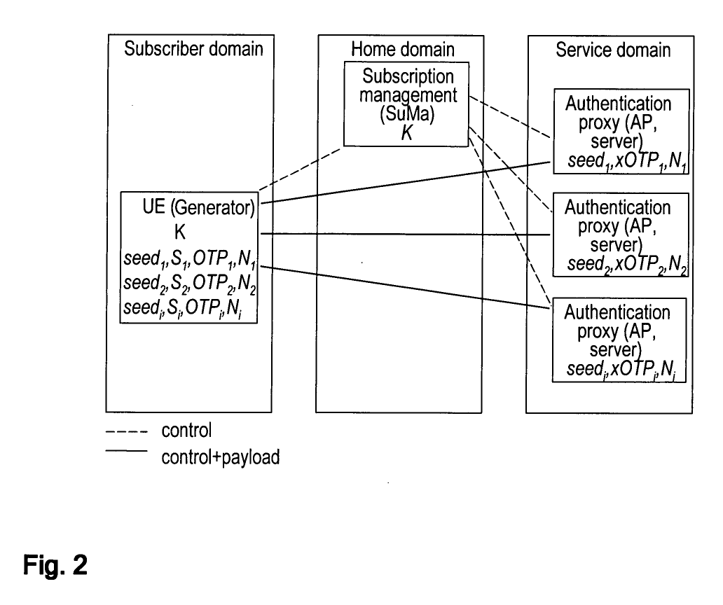

FIG. 2 shows an OTP architecture as applied in the present embodiment. The OTP architecture requires a secure channel between subscriber and home domains, and between the home domain and a service domain. The former may be e.g. SMS and the latter an IPSec VPN (Internet Protocol Security Virtual Private Network). A mobile handset can serve SIMless terminals that cannot use SMS. Alternatively the SIMless terminal can use HTTPS when initially contacting the home domain. The basic ideas behind the OTP architecture are:
1. The subscriber visits the home domain only occasionally to get a secret key. He visits the service domain more regularly.
2. Multiple service domain keys (OTP sequences, “session keys”) are derived from the single secret key.
3. Services are not aware of each other's keys (OTP sequences).
4. Eavesdropped OTP cannot be used for later authentication (basic OTP property).
5. Stored OTP cannot be used for later authentication (basic OTP property; protects from malicious service domain personnel).

Public key certificates provide similar properties, but the required Public Key infrastructure is complex and expensive. OTP focuses on authentication only and in the mobile environment its small messages with few attributes are an advantage.

It is to be noted that authentication proxies (APs) as shown in FIG. 2 each represent a more generic authentication function in front of any (https) server than the authentication proxy in the 3GPP standards.

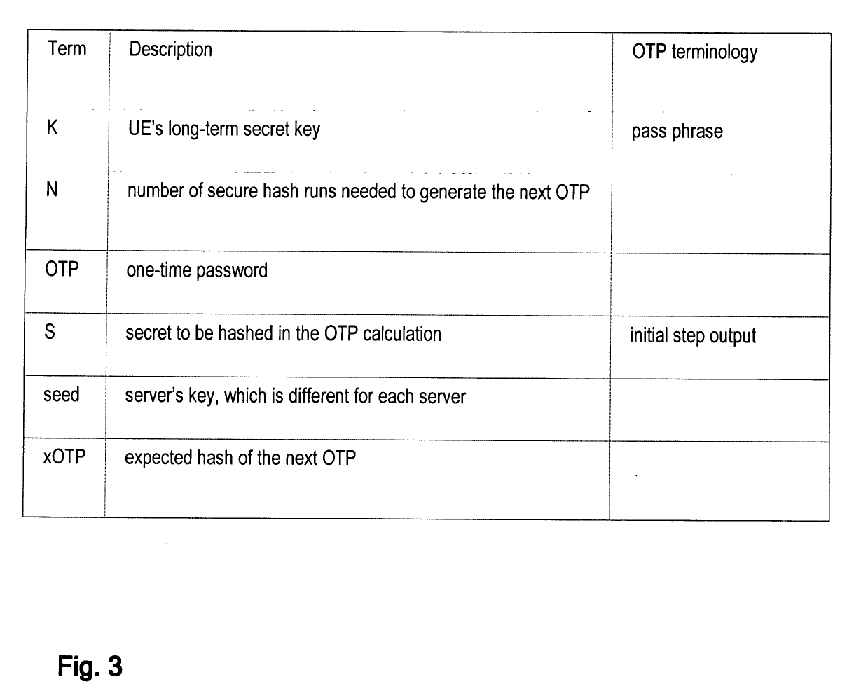

The relationships between the domains shown in FIG. 2 will be described by referring to the table illustrated in FIG. 3 describing OTP key generation data. The dashed lines in FIG. 2 illustrate control signaling and the solid lines control and payload transmittal.

A user equipment UE shown in FIG. 2 calculates S by combining K received from a subscription management entity SuMa and a seed received from an authentication proxy AP. According to FIG. 3, S represents a secret to be hashed in the OTP calculation, K is a long-term secret key of the UE, and the seed is a key of the authentication proxy (server), which is different for each server. Each S starts a unique OTP sequence. The seeds are AP (service) specific. Thus, a single K suffices to establish several service specific OTP sequences. During consequent authentications the UE calculates the next OTP, which will be described below. In the revocation cases to be described below the UE deletes all or part of the secret key material.

The SuMa generates the K on behalf of the user. It also calculates the first expected response for the AP and stores the association between UE and AP, which will be described below. The SuMa does not participate subsequent authentications or the use of the service. The SuMa may send a key revocation command to the UE and AP. The SuMa may store key material for backup purposes. During revocation the stored keys must be deleted. The SuMa may assist in re-synchronizing UE and AP in case of a corrupted OTP, xOTP or N at either end. N is the number of secure hash runs needed to generate the next OTP, and xOTP is the expected hash of the next OTP that will be described in greater detail below.

The AP authenticates the UE when accessing the service. It generates the seed to initiate the OTP sequence. As described in greater detail below the AP requests the first OTP from the SuMa since it does not know K and therefore cannot verify the first OTP. On successful authentication the AP stores the OTP. The AP can verify the subsequent OTPs based on the stored OTP during later authentications without assistance from the SuMa. On revocation the AP deletes the stored OTP.

Using the OTP standard terminology, the UE is the generator and the AP is the server. The Subscription management SuMa generates the secret key K (pass phrase) on the user's behalf. The server generates the seed. Any entity may initiate key revocation.

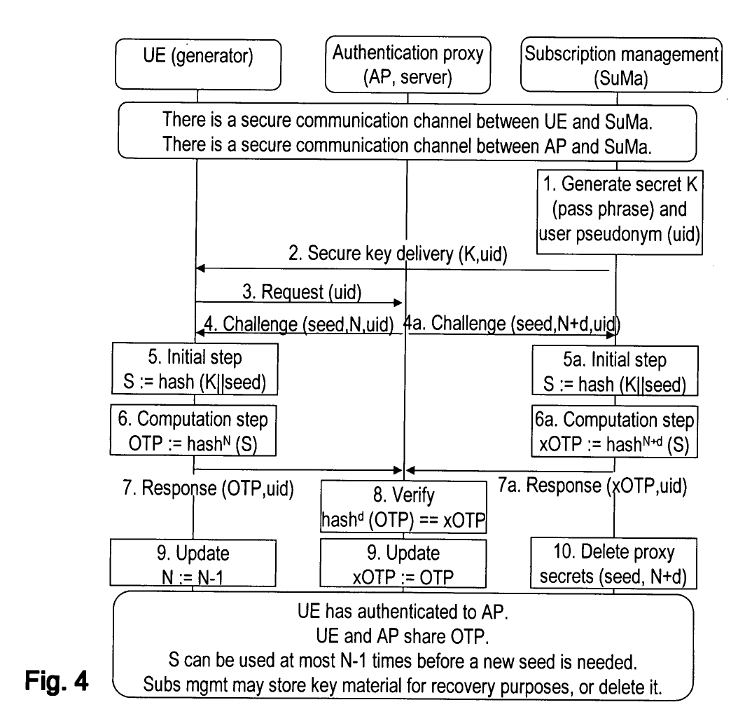

Referring to FIG. 4, in the following the OTP delivery is described.

The UE and the SuMa have mutually authenticated before the OTP delivery starts. The communication channel must be a secure channel, e.g. SMS or an encrypted channel. The SuMa and the authentication proxy AP share a (semi-) permanent security association, and encrypted communication channel (e.g. IPSec VPN). E.g. a TLS handshake procedure with a server certificate will provide the secure channel, and a similar operation is possible with IKE (Internet Key Exchange) or IKEv2 as well. A TLS, IKE or IKEv2 standard may be modified to take the usage of one time passwords into account. Another alternative is to keep the TLS or IPSec channel only “half authenticated” (i.e. client verifies server identity), and authenticate the client on top of that channel.

Steps 4 to 7 in FIG. 4 are symmetric in the UE and the SuMa. Both UE and SuMa calculate the first OTP based on the K and seed.

In step 1 in FIG. 4 the SuMa generates the random secret key K (pass phrase) and a pseudonym uid for the user. The SuMa stores the (K, uid) pair into its database. All the parties refer to the UE with the uid in the following messages. It is a handle to the SuMa database and only SuMa can associate it with the real UE identity.

In step 2 in FIG. 4 the SuMa sends K to the UE over the secure channel.

In step 3 in FIG. 4 the UE requests a service from the AP.

In step 4 in FIG. 4 the AP authenticates UE before granting service by sending a challenge request to the UE. A random seed and a maximum number N of generated OTPs are included in the challenge request.

In step 4a in FIG. 4 the AP copies the seed and N+d to the SuMa to get the expected response. The AP adds a positive offset d to the number of hash rounds in the SuMa. Hence the SuMa will not know the actual number of hash rounds the UE will be calculating.

In an initial step (steps 5 and 5a in FIG. 4), K is concatenated with the seed from the AP. This non-secret seed allows clients to use the same secret pass-phrase on multiple machines (using different seeds) and to safely recycle their secret pass-phrases by changing the seed. The result of the concatenation is passed through the secure hash function. The result S is stored for later authentications with the AP. The UE stores multiple (APi, Si) pairs. The UE deletes the seed as it will not be needed any more.

In a computation step (step 6 in FIG. 4), the UE produces the first one-time password to be used by passing S through the secure hash function a number of times (N) specified by the AP. The next one-time password to be used will be generated by passing S though the secure hash function N-1 times. An eavesdropper who has monitored the transmission of a one-time password would not be able to generate the next required password because doing so would mean inverting the hash function.

As can be seen from step 6a in FIG. 4, the SuMa runs the hash function d more times than the UE to produce the xOTP, without knowing the values N and d. In normal operation xOTP contains the OTP from a previous successful authentication. On initialization the SuMa generates a pseudo-predecessor of the first OTP.

In steps 7 and 7a in FIG. 4 the UE and the SuMa send the OTP and xOTP responses to the AP.

The AP has a database containing, for each user, the one-time password xOTP of a newly initialized sequence (the pseudo-predecessor). To authenticate the user, the AP runs the OTP received from the UE through the secure hash function d times (step 8 in FIG. 4) to see if it matches with the expected response xOTP. If the result of this operation matches the stored xOTP, the authentication is successful.

In steps 9 in FIG. 4, a state update for the next authentication is performed: the AP stores the accepted OTP as xOTP, and the UE decreases the number of hash rounds N. In addition, the AP may keep a counter N for synchronization purposes as well.

In step 10, the SuMa deletes the seed and N parameters from the authentication proxy. This is to prevent external attackers or malicious insiders at SuMa from masquerading as UE.

After a successful authentication the UE and AP share the OTP, which will be used for verifying the response to the next authentication. S can be used N-1 times before generating a new seed. Any party may decide to use S fewer times and revoke it earlier due to local policy or on suspicion of fraud as described below.

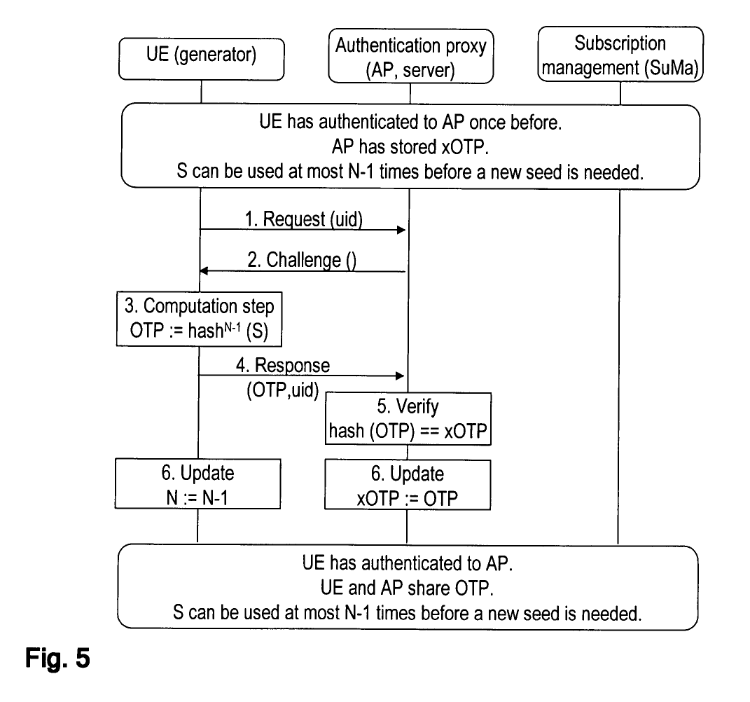

Referring to FIG. 5, in the following the OTP usage will be described.

The AP has stored xOTP from the previous successful authentication. It will be used for verifying the response to the next authentication. S can be used N-1 times before generating a new seed. As described above, any party may decide to use S fewer times and revoke it earlier due to local policy or on suspicion of fraud.

In step 1 in FIG. 5 the UE requests a service from the AP.

In step 2 in FIG. 5 the AP challenges the UE before granting the service.

In the computation step (step 3 in FIG. 5), the UE produces the one-time password to be used by passing S through the secure hash function N-1 times, N being specified by the AP. The next one-time password to be used is generated by passing S though the secure hash function N-2 times. An eavesdropper who has monitored the transmission of a one-time password would not be able to generate the next required password because doing so would mean inverting the hash function.

In step 4 in FIG. 5 the UE sends the OTP response to the AP.

The AP has a database containing, for each user, the one-time password xOTP of the previous authentication. To authenticate the user, the AP runs the OTP received from the UE through the secure hash function once (step 5 in FIG. 5). If the result of this operation matches the stored xOTP, the authentication is successful.

In steps 6 in FIG. 5 a state update for the next authentication is performed: the AP stores the accepted OTP as xOTP, and the UE decreases the number of hash rounds N. The AP may keep a counter N for synchronization purposes as well.

According to FIG. 5, the UE has authenticated to the AP. The UE and the AP share the OTP. S may be used at most N-1 times before a new seed is needed.

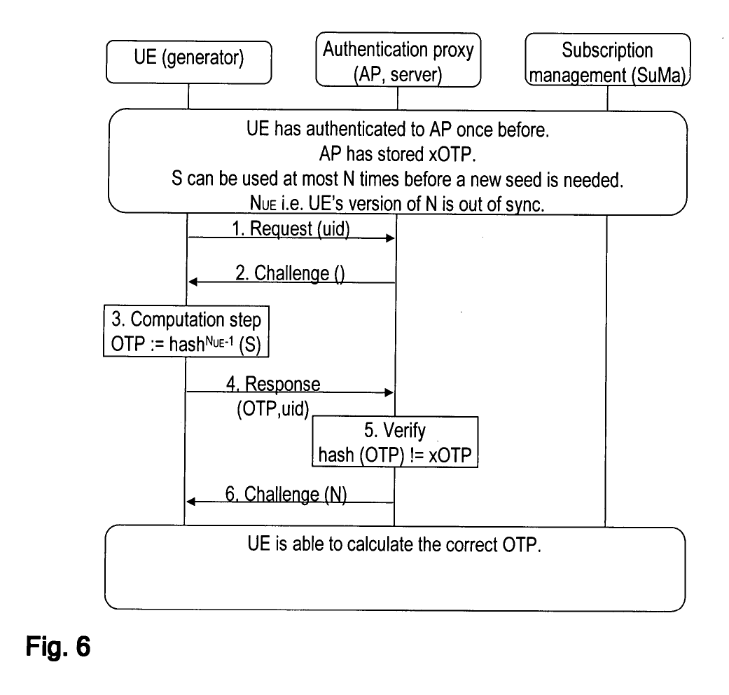

FIG. 6 shows an OTP synchronization in case the UE's version of N, i.e. NUE, is out of synchronization. The authentication attempt steps 1-4 are like in the successful authentication case shown in FIG. 5.

However, in step 5 in FIG. 6 the AP detects that the response OTP and the stored xOTP do not match.

Thus, in step 6 in FIG. 6 the AP advises the UE about the correct sequence number N by sending a challenge request including N to the UE. With this information the UE is able to calculate the correct OTP.

An eavesdropper cannot use the N information alone to forge OTP. An active attacker could cause denial of service at most. After synchronization the user will resend the request and authenticate successfully.

Additional heuristics may be used at the AP end to limit the notifications to probable honest UEs: if the AP stores a couple of most recent OTPs, it can check if OTP matches any of those, and send notification only if it did. This blocks notifications to attackers who pick up OTP randomly.

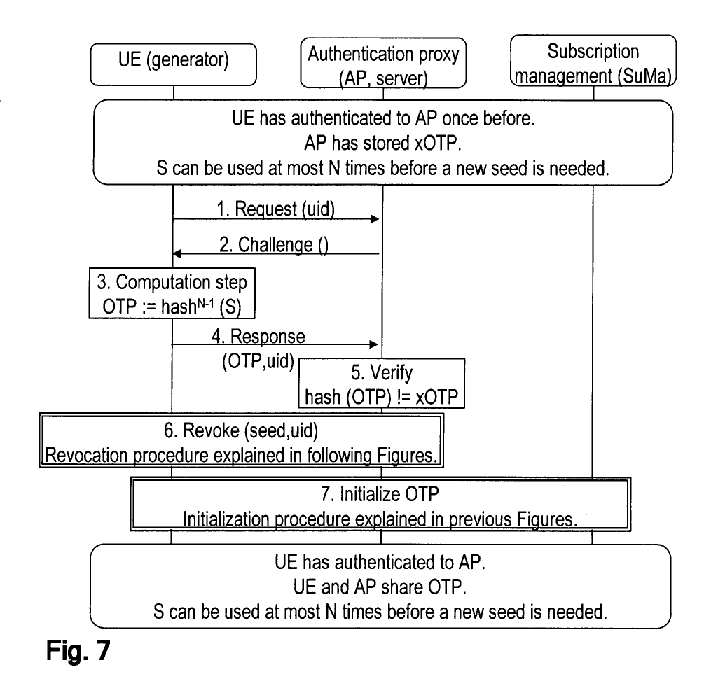

FIG. 7 shows an OTP synchronization when S or xOTP has been corrupted. The authentication attempt steps 1-4 are like in the successful authentication case shown in FIG. 5.

However, in step 5 in FIG. 7 the AP detects that the response OTP and the stored xOTP do not match because S or xOTP has been corrupted.

Thus, in step 6 in FIG. 7 the AP performs a revocation procedure for revoking the seed in the UE, which will be described below. After the revoke operation, in step 7 an OTP is initialized using the initialization procedure described in connection with FIG. 4.

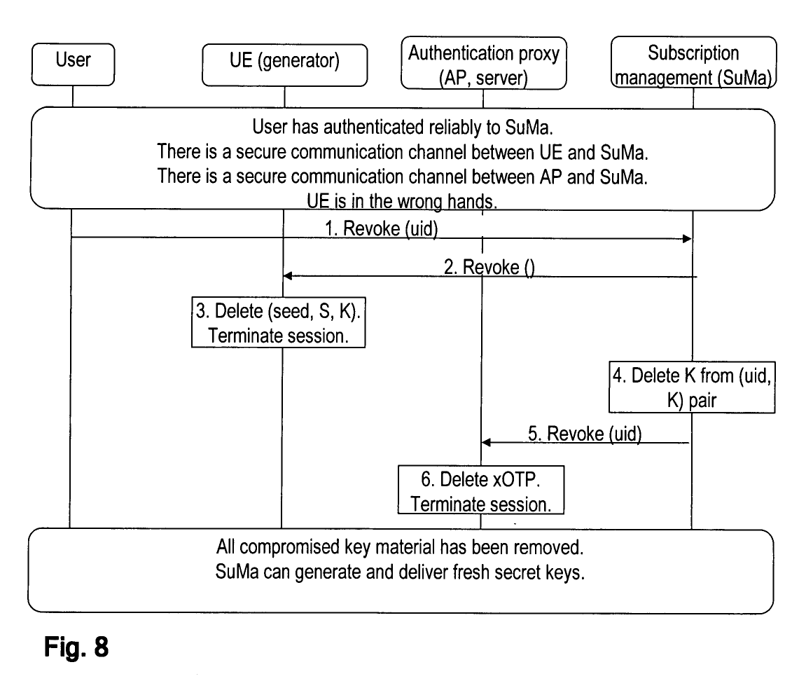

Referring to FIGS. 8 to 10 in the following the OTP revocation procedure will be described.

FIG. 8 shows a user initiated OTP revocation. The user has authenticated reliably to the SuMa. There is a secure communication channel between the UE and the SuMa or SuMa is able to establish one on demand. There is also a secure communication channel between the AP and the SuMa. When the user detects that the UE is in the wrong hands, the user informs the SuMa about this (step 1 in FIG. 8) possibly over an out-of-band communication channel the details of which are not considered further. Thereupon, the SuMa sends a revoke request to the UE (step 2 in FIG. 8). The UE deletes the seed, S and K and terminates the session (step 3 in FIG. 8). In addition, the SuMa deletes K from the (uid, K) pair, and sends a revoke request to all the relevant APs. The AP deletes the xOTP and terminates possible existing sessions with the compromised UE. With these operations, all compromised key material has been removed from the UE, AP and SuMa. The SuMa may generate and deliver new secret keys.

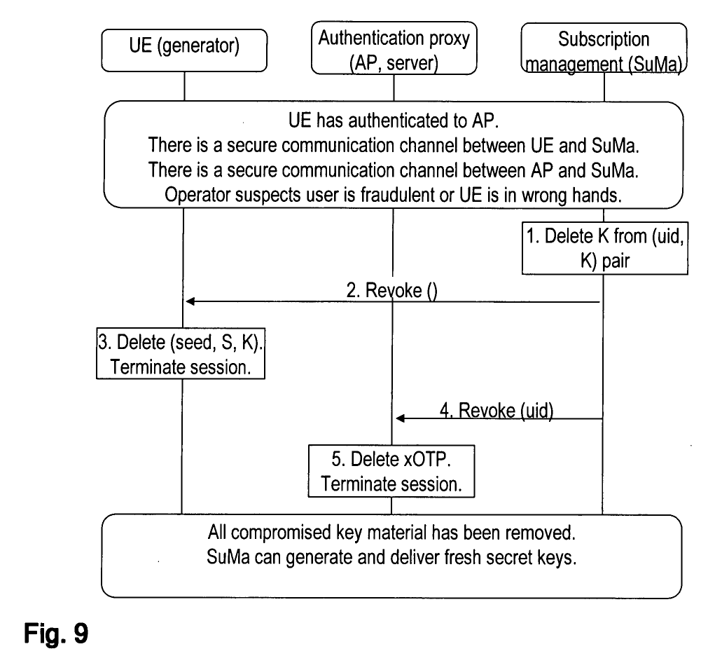

FIG. 9 shows a SuMa initiated OTP revocation. The UE has authenticated to some APs and shares secret key material with them (but different APs will not see each other's key material). There is a secure communication channel between the UE and the SuMa. There is also a secure communication channel between the APs and the SuMa. When the SuMa operator suspects the user of the UE is fraudulent or the UE is in the wrong hands, the SuMa deletes K from the (uid, K) pair (step 1 in FIG. 9). Thereupon, the SuMa sends a revoke request to the UE (step 2 in FIG. 9). The UE deletes the seeds, Ss and K and terminates the sessions (step 3 in FIG. 9). In addition, the SuMa sends a revoke request to the APs. The APs delete the xOTP and terminate the sessions. With these operations, all compromised key material has been removed from the UE, APs and SuMa. The SuMa may generate and deliver new secret keys.

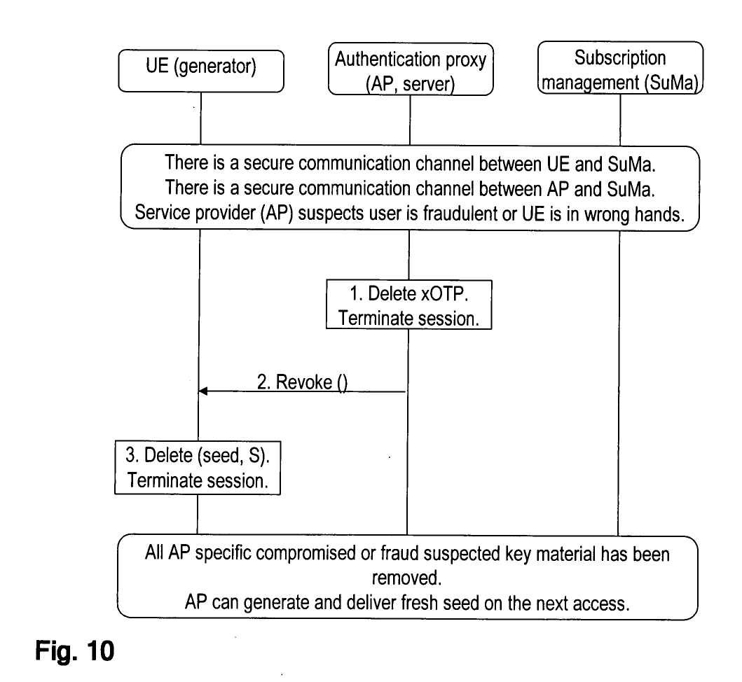

FIG. 10 shows an AP initiated OTP revocation. There is a secure communication channel between the UE and the SuMa. There is also a secure communication channel between the AP and the SuMa. When the service provider (AP) suspects the user of the UE is fraudulent or the UE is in the wrong hands, the AP deletes the xOTP and terminates the session. Then, the AP sends a revoke request to the UE, which in response deletes the AP specific seed and S and terminates the session. With these operations, all AP specific compromised or fraud suspected key material has been removed from the UE and the AP. The AP may generate and deliver a new seed on the next access. The UE may continue communication with the other APs since this revocation removed only the keys related to one AP. The SuMa does not store AP specific data, hence it is not involved in the revocation.

To minimize the SMS load that the http digest password delivery causes, as described above an embodiment of the invention uses the seed and hash approach. The communication network system generates the seed and optionally a new secret key, and sends at least the secret key to the user equipment over SMS. It is also possible to use a fixed secret key for all subscribers or one key for a group of one or more subscribers. The hash function generates the first password from the seed and the secret key, and a configurable number of further passwords. The later passwords do not require short messages. The passwords are used in the reverse order. In other words, the last generated one is used first to prevent eavesdroppers from calculating the rest of the password sequence.

The communication network system generates and sends a new seed (and secret key) to the user equipment after the number of generated passwords reaches a configurable threshold or a timeout expires. It is also possible that the user equipment requests a new seed (and secret key).

Requiring the subscriber to enter a PIN (Personal Identification Number) code before applying the hash function can enhance the security of the mechanism. The PIN is a local locking mechanism that the user equipment or terminal, SIM or UICC enforces. PIN query may be used for generating the first password from the seed or for generating any of the later passwords. The password itself will remain invisible to the subscriber.

Applying different seeds, secret keys and/or hash functions can create password domains. The domain specific password sequences can be independent or rely on a common master sequence. Domain specific sequences for applications a and b diverge from the beginning (like twigs from the root of a bush):

pwd-a(0):=hash (seed, key-a)

pwd-a(1):=hash (pwd-a(0), key-a)

. . .

pwd-b(0):=hash (seed, key-b)

pwd-b(1):=hash (pwd-b(0), key-b)

A master sequence may provide a better synchronization point for the application passwords (like a bole where the branches attach):

pwd-m(0):=hash (seed, key-m)

pwd-m(1):=hash (pwd-m(0), key-m)

. . .

pwd-a(0):=hash (pwd-m(0), key-a); first branch

pwd-a(1):=hash (pwd-a(0), key-a)

pwd-a(2):=hash (pwd-a(1), key-a)

pwd-a(3):=hash (pwd-a(2), key-a)

pwd-a(4):=hash (pwd-m(1), key-a); second branch

pwd-a(5):=hash (pwd-a(4), key-a)

. . .

pwd-b(0):=hash (pwd-m(0), key-b); first branch

pwd-b(1):=hash (pwd-m(1), key-b); the branches are real short—they all start from the bole

pwd-b(2):=hash (pwd-m(2), key-b)

pwd-b(3):=hash (pwd-m(3), key-b)

pwd-b(4):=hash (pwd-m(4), key-b)

pwd-b(5):=hash (pwd-m(5), key-b)

. . .

It is to be understood that the above description of the preferred embodiments is illustrative of the invention and is not to be construed as limiting the invention. Various modifications and applications may occur to those skilled in the art without departing from the true spirit and scope of the invention as defined by the appended claims.

1. A user equipment for accessing a communication network system, the user equipment comprising:
receiving means for receiving key information for calculating at least one password from the communication network system via a secure channel;
generating means for generating the at least one password on a basis of the key information received by the receiving means; and
authenticating means for performing authentication with the communication network system using the at least one password generated by the generating means.

2. The user equipment according to claim 1, wherein the receiving means is configured to receive the key information in a Short Message Service message.

3. The user equipment according to claim 1, wherein the receiving means is configured to receive encryption data from the communication network system, and the generating means is configured to generate the at least one password on a basis of a combination of the key information and the encryption data.

4. The user equipment according to claim 3, wherein the generating means is configured to apply a secure hash function to the combination of the key information and the encryption data for generating the at least one password.

5. The user equipment according to claim 3, wherein the receiving means is configured to receive the key information from a subscription management entity of the communication network system and the encryption data from a service management entity of the communication network system.

6. The user equipment according to claim 1, wherein the receiving means is configured to receive a request for generating a password from the communication network system, the request including encryption data, and wherein the generating means is configured to generate the at least one password in response to the request using the key information and the encryption data included in the request.

7. The user equipment according to claim 6, wherein the receiving means is configured to receive a revocation request for revoking a password from the communication network system, the user equipment further comprising deleting means for deleting the key information and the encryption data in response to the revocation request.

8. The user equipment according to claim 6, further comprising:
detecting means for detecting a non-permitted use of the user equipment; and
deleting means for deleting the key information and the encryption data in response to the non-permitted use detected by the detecting means.

9. The user equipment according to claim 3, wherein the encryption data are not confidential data.

10. The user equipment according to claim 3, wherein the encryption data comprises a count value indicating validity of the encryption data, the user equipment further comprising updating means for decreasing the count value with every password calculation.

11. A network entity for managing subscribers in a communication network system, the network entity comprising:
generating means for generating key information for a user equipment; and
sending means for sending the key information generated by the generating means to the user equipment via a secure channel.

12. The network entity according to claim 11, wherein the sending means is configured to send the key information in a Short Message Service message.

13. The network entity according to claim 11, wherein the sending means is configured to send encryption data to the user equipment.

14. The network entity according to claim 11, further comprising receiving means for receiving a request for generating a password from a service management entity of the communication network system, the request including encryption data, wherein the generating means is configured to generate a password in response to the request using the key information and the encryption data and the sending means is configured to send the password generated by the generating means to the service management entity.

15. The network entity according to claim 11, further comprising deleting means for deleting the key information, wherein the sending means is configured to send a revocation request for revoking a password to the user equipment.

16. The network entity according to claim 15, further comprising detecting means for detecting a non-permitted use of the user equipment, wherein the deleting means is configured to delete the key information and the sending means is configured to send the revocation request to the user equipment in response to a detection of the non-permitted use of the user equipment by the detecting means.

17. The network entity according to claim 11, wherein the network entity is located in the user equipment.

18. A network entity for managing services in a communication network system, the network entity comprising:
sending means for sending a request for generating a password to a user equipment requesting a service, the request including encryption data for generating at least one password in the user equipment;
receiving means for receiving the password generated on a basis of the encryption data from the user equipment; and
authenticating means for verifying the password received by the receiving means from the user equipment.

19. The network entity according to claim 18, wherein the sending means is further configured to send the request for generating the password to a subscriber management entity of the communication network system, the receiving means is configured to receive the password generated on a basis of the encryption data from the subscriber management entity, and the authenticating means is configured to verify the password received from the user equipment on a basis of the password received from the subscriber management entity.

20. The network entity according to claim 18, wherein in case the authentication means does not verify the password from the user equipment, the sending means is configured to re-send a request for generating a password to the user equipment, the request including updated encryption data.

21. The network entity according to claim 20, further comprising:
storing means for storing passwords, wherein the authentication means is configured to verify the password from the user equipment against at least one of the passwords stored by the storing means, and the sending means is configured to re-send the request for generating a password in case the authentication means does not verify the password from the user equipment against the at least one of the passwords stored by the storing means.

22. The network entity according to claim 18, further comprising deleting means for deleting the password received from the user equipment, wherein the sending means is configured to send a revocation request for revoking the password to the user equipment.

23. The network entity according to claim 22, further comprising detecting means for detecting a non-permitted use of the user equipment, wherein the deleting means is configured to delete the password and the sending means is configured to send the revocation request to the user equipment in response to a detection of the non-permitted use of the user equipment by the detecting means.

24. The network entity according to claim 18, wherein the encryption data comprises a count value indicating validity of the encryption data, the network entity further comprising updating means for decreasing the count value with every password received from the user equipment.

25. The network entity according to claim 18, wherein the network entity is located in the user equipment.

26. A communication network system comprising:
a first network entity comprising generating means for generating key information for a user equipment, and sending means for sending the key information generated by the generating means to the user equipment via a secure channel; and
a second network entity comprising sending means for sending a request for generating a password to a user equipment requesting a service, the request including encryption data for generating at least one password in the user equipment, receiving means for receiving the password generated on a basis of the encryption data from the user equipment, and authenticating means for verifying the password received by the receiving means from the user equipment.

27. The communication network system according to claim 26, wherein the first and second network entities are located in different network sub-systems.

28. A communication system comprising:
a user equipment comprising receiving means for receiving key information for calculating at least one password from a communication network system via a secure channel, generating means for generating the at least one password on a basis of the key information received by the receiving means, and authenticating means for performing authentication with the communication network system using the at least one password generated by the generating means; and
a network entity comprising generating means for generating the key information for the user equipment, and sending means for sending the key information generated by the generating means to the user equipment via the secure channel.

29. A communication system comprising:
a user equipment comprising receiving means for receiving key information for calculating at least one password from a communication network system via a secure channel, generating means for generating the at least one password on a basis of the key information received by the receiving means, and authenticating means for performing authentication with the communication network system using the at least one password generated by the generating means; and
a network entity comprising sending means for sending a request for generating a password to the user equipment requesting a service, the request including encryption data for generating the at least one password in the user equipment, receiving means for receiving the password generated on a basis of the encryption data from the user equipment, and authenticating means for verifying the password received by the receiving means from the user equipment.

30. A communication system comprising:
a user equipment comprising receiving means for receiving key information for calculating at least one password from a communication network system via a secure channel, generating means for generating the at least one password on a basis of the key information received by the receiving means, and authenticating means for performing authentication with the communication network system using the at least one password generated by the generating means;
a first network entity comprising generating means for generating the key information for the user equipment, and sending means for sending the key information generated by the generating means to the user equipment via the secure channel; and
a second network entity comprising sending means for sending a request for generating a password to the user equipment requesting a service, the request including encryption data for generating the at least one password in the user equipment, receiving means for receiving the password generated on a basis of the encryption data from the user equipment, and authenticating means for verifying the password received by the receiving means from the user equipment.

31. A method of accessing a communication network system, the method comprising:
a receiving step of receiving key information for calculating at least one password from the communication network system via a secure channel;
a generating step of generating the at least one password on a basis of the key information received in the receiving step; and
an authenticating step of performing authentication with the communication network system using the at least one password generated in the generating step.

32. A method of managing subscribers in a communication network system, the method comprising:
a generating step of generating key information for a user equipment; and
a sending step of sending the key information generated in the generating step to the user equipment via a secure channel.

33. A method of managing services in a communication network system, the method comprising:
a sending step of sending a request for generating a password to a user equipment requesting a service, the request including encryption data for generating at least one password in the user equipment;
a receiving step of receiving the password generated on a basis of the encryption data from the user equipment; and
an authenticating step of verifying the password received in the receiving step from the user equipment.

34. A computer program embodied on a computer readable medium, comprising software code portions for performing the following steps:
receiving key information for calculating at least one password from a communication network system via a secure channel;
generating the at least one password on a basis of the key information received in the receiving step;
performing authentication with the communication network system using the at least one password generated in the generating step.

35. A computer program embodied on a computer readable medium, comprising software code portions for performing the following steps:
generating key information for a user equipment; and
sending the key information generated in the generating step to the user equipment via a secure channel.

36. A computer program embodied on a computer readable medium, comprising software code portions for performing the following steps:
sending a request for generating a password to a user equipment requesting a service, the request including encryption data for generating at least one password in the user equipment;
receiving the password generated on a basis of the encryption data from the user equipment; and
verifying the password received in the receiving step from the user equipment.

37. The computer program according to claim 34, wherein the computer program is directly loadable into an internal memory of a computer.
